(19) United States
(12) Patent Application Publication
(10) Pub. No.: US 2016/0229710 A1
(43) Pub. Date: Aug. 11, 2016

(54) Cutting Fluid Processing Device

(71) Applicants: Yuan He, Dalian (CN); Xiaokun He, Dalian (CN)

(72) Inventors: Yuan He, Dalian (CN); Xiaokun He, Dalian (CN)

(21) Appl. No.: 15/016,481

(22) Filed: Feb. 5, 2016

Related U.S. Application Data
(60) Provisional application No. 62/114,249, filed on Feb. 10, 2015.

(51) Int. Cl. C02F 1/32; B23Q 11/10

(52) U.S. Cl. CPC C02F 1/325; B23Q 11/1069; C02F 2201/32

(57) ABSTRACT

A cutting fluid processing device for recycling used cutting fluid. The cutting fluid processing device includes a container having a hollow interior volume, a fluid inlet, and a fluid outlet. The container includes an ultraviolet light source therein, wherein the ultraviolet light source is adapted to sanitize the cutting fluid by killing bacteria therein. The container further includes a waste outlet for removing contaminants from the container. The container further includes a filter for use in separating contaminants or particulates from the cutting fluid prior to escaping the container via the fluid outlet. Thus, the cutting fluid processing device allows cutting fluid to be treated so that it can be reused.

### CROSS REFERENCE TO RELATED APPLICATION

This application claims the benefit of U.S. Provisional Application No. 62/114,249 filed on Feb. 10, 2015. The above identified patent application is herein incorporated by reference in its entirety to provide continuity of disclosure.

### BACKGROUND OF THE INVENTION

### Field of the Invention

The present invention relates to fluid treatment devices. More specifically, the present invention provides a cutting fluid treatment device for sanitizing cutting fluid so that it can be reused.

Cutting fluid is a lubricant commonly used in metalworking and provides several benefits. Cutting fluid helps to cool a metal tool to prevent the tool from overheating, which may result in thermal deformation of the tool. Cutting fluid also helps to flush chips and helps to lubricate a tool's cutting edge. In this way, cutting fluid helps to improve the useful life of a tool and allows the tool to function properly.

After use, cutting fluid can become contaminated by unwanted oil and particulate matter. Repeated use of the cutting fluid causes the fluid to degrade as it becomes contaminated by oils and metal particulates. In order to continue using the cutting fluid, the oil and particulates must be filtered therefrom. Eventually, the used cutting fluid must be carefully disposed of once it has been chemically degraded and has lost its usefulness. The cutting fluid must be disposed of carefully so as to comply with environmental regulations.

Frequently disposing of cutting fluid can be costly, due to the cost of replacing the cutting fluid and disposing of the used cutting fluid. For this reason, cutting fluid is often treated and recycled in order to reduce expense and to reduce environmental impact. However, in order to reuse the cutting fluid, the cutting fluid must be processed in order to remove bacteria and other contaminants that reduce the effectiveness of the cutting fluid and that may endanger the health of workers using the cutting fluid.

Devices have been disclosed in the prior art that relate to cutting fluid treatment systems. These include devices that have been patented and published in patent application publications. These devices generally relate to devices for processing or treating cutting fluid, such as U.S. Pat. No. 7,404,906, U.S. Published Patent Application Number 2014/0145309, U.S. Pat. No. 5,997,812, U.S. Pat. No. 5,795,400, and U.S. Pat. No. 8,475,632.

These prior art devices have several known drawbacks. Devices in the prior art provide systems or processes for treating cutting fluid, however, such devices fail to utilize ultraviolet radiation in order to remove bacteria from the cutting fluid. Further, such devices lack means for filtering metal particulates and other contaminants from the cutting fluid.

In light of the devices disclosed in the prior art, it is submitted that the present invention substantially diverges in design elements from the prior art and consequently it is clear that there is a need in the art for an improvement to existing cutting fluid processing devices. In this regard the instant invention substantially fulfills these needs.

### SUMMARY OF THE INVENTION

In view of the foregoing disadvantages inherent in the known types of cutting fluid processing devices now present in the prior art, the present invention provides a new cutting fluid processing device wherein the same can be utilized for providing convenience for the user when cleaning and sanitizing cutting fluid for repeated use.

It is therefore an object of the present invention to provide a new and improved cutting fluid processing device comprising a container having a hollow interior volume, a fluid inlet, and a fluid outlet, wherein fluid can flow through the container. An ultraviolet light source is positioned within the container and is adapted to sanitize the cleaning fluid that passes therethrough. Further, a filter is provided for preventing particulate matter from flowing through the fluid outlet. The container also includes a grate for filtering contaminants and particulate matter within the cutting fluid, wherein the contaminants can be released from the container through a waste outlet.

It is another object of the present invention to provide a cutting fluid processing device comprising an ultraviolet light source for sanitizing cutting fluid and removing bacteria therefrom.

Another object of the present invention is to provide a cutting fluid processing device comprising a waste outlet for removing contaminants from the cutting fluid.

Yet another object of the present invention is to provide a cutting fluid processing device comprising a filter for filtering metal particulates and other contaminants from the cutting fluid.

Another object of the present invention is to provide a cutting fluid processing device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cross sectional view of the cutting fluid processing device.

FIG. 2 shows a perspective view of a portion of the cutting fluid processing device.

FIG. 3 shows a top-down cross sectional view of the cutting fluid processing device.

### DETAILED DESCRIPTION OF THE INVENTION

Reference is made herein to the attached drawings. Like reference numerals are used throughout the drawings to depict like or similar elements of the cutting fluid processing device. For the purposes of presenting a brief and clear description of the present invention, the preferred embodiment will be discussed as used for processing and sanitizing cutting fluid for repeated use. The figures are intended for representative purposes only and should not be considered to be limiting in any respect.

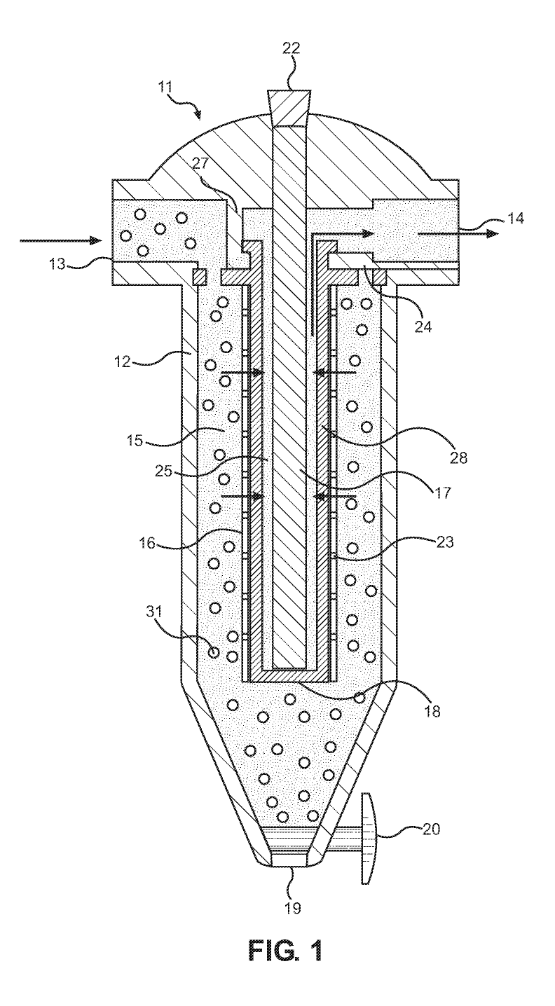

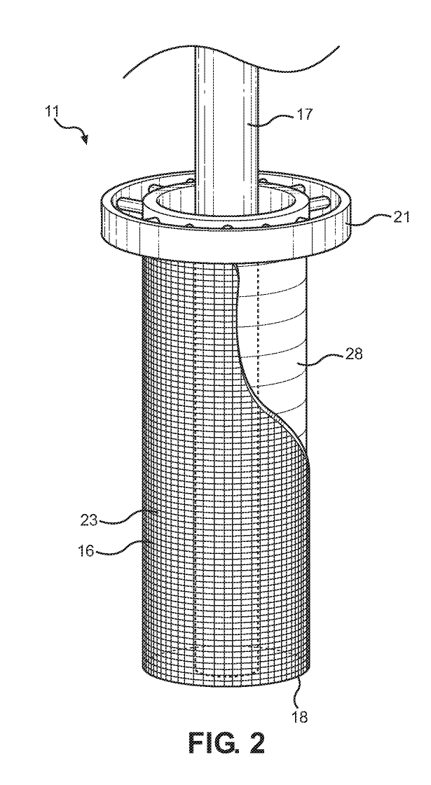

Referring now to FIGS. 1 and 2, there are shown views of the cutting fluid processing device. The cutting fluid processing device 11 comprises a container 12 having a hollow interior volume in which fluid can flow. The container 12 preferably comprises a cylindrical configuration. The container 12 comprises a fluid inlet 13 for supplying used cutting fluid to the container 12, and a fluid outlet 14 for allowing the sanitized cutting fluid to escape from the container 12. The fluid inlet 13 and fluid outlet 14 are preferably arranged at the upper end of the container 12. The lower end of the container 12 comprises a waste outlet 19 for allowing selective release of waste products from the container 12. In the illustrated embodiment, the lower end of the container 12 tapers towards the waste outlet 19 so as to direct the fluid within the container 12 to the waste outlet 19. Thus, the lower end has a substantially conical shape.

A ultraviolet (UV) light source 17 is positioned within the hollow interior volume of the container 12. The UV light source 17 is preferably cylindrical in configuration and extends from the upper end of the container 12 towards the lower end and waste outlet 19 thereof. The UV light source 17 is preferably centrally positioned within the container 12 so as to expose the cutting fluid within the container 12 to the UV radiation. The UV light source 17 serves to sanitize the cutting fluid within the container 12 and helps to kill bacteria within the cutting fluid. The upper end of the container 12 comprises a port 22 for connecting the UV light source 17 to an external power source. The upper end of the container 12 may further include a lid that can be removed in order to provide access to the UV light source 17 for cleaning or replacing the same.

The UV light source 17 is preferably enclosed within a support 28 having a filter 16 therearound. The support 28 comprises a tubular member having an open upper end 21, a closed lower end 18, and openings along the sidewalls thereof so that fluid can pass therethrough. The support 28 extends from the upper end of the container 12 towards the lower end thereof. The support 28 comprises a cylindrical configuration and comprises a diameter greater than that of the UV light source 17 so that the interior volume of the container 12 is divided into an inner volume 25 between the UV light source 17 and the support 28, and an outer volume 15 between the wall of the container 12 and the support 28.

A filter 16 having pores 23 is disposed on the exterior of the support 28 wherein the support 28 helps the filter 16 to retain its shape and configuration as fluid flows thereover. The filter 16 extends from the upper end of the container 12 to the lower end thereof and substantially covers the support 28. In this way, fluid must pass through the filter 16 in order to move from the outer volume 15 to the inner volume 25. Further, the container 12 includes one or more barriers 24, 27 that prevent fluid in the outer volume 15 from reaching the fluid outlet 14 without having passed through the filter 16. The filter 16 allows cutting fluid to pass therethrough and prevents debris and particulate matter from passing into the inner volume 25, wherein fluid in the inner volume 25 can flow to the fluid outlet 14. Thus, the filter 16 includes a pore size suited to prevent cutting fluid debris and contaminants from passing therethrough. It is not desired to limit the exact pore size of the filter 16.

Since particular matter 31 cannot pass through the filter 16, the outer volume 15 will include an increasing amount of particulate matter therein as used cutting fluid flows into the container 12. The particulate matter 31 may settle to the bottom of the container 12 under the force of gravity due to the higher density thereof relative to the fluid. In order to remove the accumulated particulate matter 31, the lower end of the container 12 comprises a waste outlet 19 having a control valve 20 thereon that allows the user to selectively release the particulate matter and other waste through the waste outlet 19. The lower end comprises a conical configuration so as to direct all of the waste product towards the waste outlet 19 so that the waste products are not retained within the container 12.

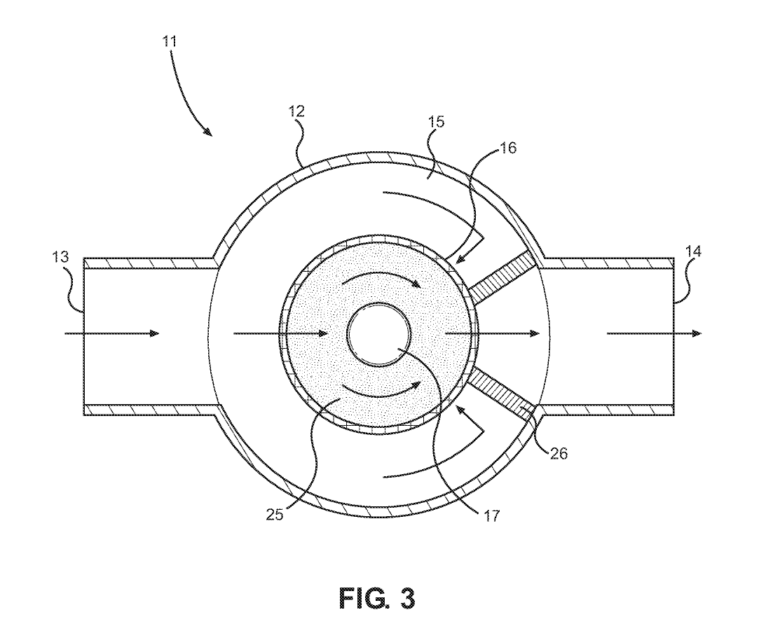

Referring now to FIG. 3, there is shown a top-down cross sectional view of the cutting fluid processing device. In operation, used cutting fluid is supplied to the container 12 through the fluid inlet 13. The fluid flows into the container 12 and into the outer volume 15 thereof. The ultraviolet light source 17 positioned within the container 12 sanitizes the cutting fluid by killing the bacteria therein as the fluid circulates within the container 12. As the used cutting fluid flows through the container 12, the contaminants settle to the bottom of the container 12. The lower end comprises a waste outlet having a control valve thereon for allowing the waste outlet to be opened or closed.

The cutting fluid also passes through the filter 16 and into the inner volume 25 of the container 12, wherein the filter 16 prevents particulate matter from passing into the inner volume 25 thereof. The cutting fluid in the inner volume can then flow toward the fluid outlet 14, wherein the cutting fluid can only reach the fluid outlet 14 after having passed through the filter 16. In this way, the cutting fluid has been sanitized by the UV light source and particulate matter has been removed via the filter 16. The sanitized cutting fluid from the fluid outlet 14 can then be collected and reused.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A cutting fluid processing device, comprising:
a container having a hollow interior volume, a fluid inlet, and a fluid outlet;
an ultraviolet light source positioned within the interior volume, wherein the ultraviolet light source is adapted to sanitize a fluid within the hollow interior volume;
a grate positioned within the hollow interior volume adapted to separate a contaminant from the fluid.

2. The cutting fluid processing device of claim 1, further comprising:
a filter surrounding the ultraviolet light source and defining an inner volume between the filter and the ultraviolet light source, wherein fluid must pass through the filter in order to exit the container via the fluid outlet.

3. The cutting fluid processing device of claim 1, wherein the container comprises a cylindrical configuration.

4. The cutting fluid processing device of claim 1, wherein a lower end of the container tapers towards a waste outlet.

5. The cutting fluid processing device of claim 4, wherein the waste outlet comprises a control valve adapted to close or open the waste outlet.

6. The cutting fluid processing device of claim 1, wherein the ultraviolet light source is positioned substantially centrally within said container.

7. The cutting fluid processing device of claim 1, wherein the ultraviolet light source is cylindrical in configuration.

8. A cutting fluid processing device, comprising:
a container having a hollow interior volume, a fluid inlet, a fluid outlet, and a waste outlet;
a filter surrounding the ultraviolet light source and defining an inner volume between the filter and the ultraviolet light source, wherein fluid must pass through the filter in order to exit the container via the fluid outlet;
an ultraviolet light source positioned within the interior volume, wherein the ultraviolet light source is adapted to sanitize a fluid within the hollow interior volume.

9. The cutting fluid processing device of claim 8, wherein the ultraviolet light source comprises a cylindrical configuration and extends from an upper end of the container towards the lower end thereof.

10. The cutting fluid processing device of claim 9, wherein the filter comprises a cylindrical configuration.

11. The cutting fluid processing device of claim 8, wherein the waste outlet comprises a valve thereon for selectively opening the waste outlet.
